(19) United States
(12) Patent Application Publication
(10) Pub. No.: US 2025/0236032 A1
(43) Pub. Date: Jul. 24, 2025

(54) Monolithic Handle For A Safety Razor

(71) Applicant: Edgewell Personal Care Brands, LLC, Chesterfield, MO (US)

(72) Inventors: Stephan Fischer, Gevelsberg (DE); Jochen Thoene, Wuppertal (DE)

(21) Appl. No.: 18/855,542

(22) PCT Filed: Apr. 18, 2023
(86) PCT No.: PCT/US2023/065871

§ 371 Date: Oct. 9, 2024

Related U.S. Application Data
(60) Provisional application No. 63/334,796, filed on Apr. 26, 2022.

(51) Int. Cl. B26B 21/52

(52) U.S. Cl. CPC B26B 21/522; B26B 21/521; B26B 21/528

(57) ABSTRACT

A handle for a safety razor having a razor cartridge connected to the handle has a first and second arm connected at one end in a general U or V shape. Each arm terminates in pivotal support structure for the razor cartridge. A top cover and a bottom cover both extend inwardly of a head end region of a respective one of the arms. The cover, in combination with the head end regions at least partially enclose structures that both interconnect the head end regions to define a primed-condition predetermined dimension (W) across the pivotal support structures, and permit the head end regions to be guidedly flexed together upon application of finger pressure to the head end regions. A biasing member is integrally formed with one of the arms and a terminal lead-in portion of the biasing member is received in an aperture of the other arm.

### CROSS-REFERENCE TO RELATED APPLICATIONS

This application claims priority to U.S. Provisional Patent Application No. 63/334,796, filed on Apr. 26, 2022, the content of which is incorporated herein by reference in its entirety.

### BACKGROUND

### 1. Technical Field

The present disclosure relates to safety razors in general and, more particularly, to a handle for a safety razor comprising a monolithic body.

### 2. Background

Many modern so-called “system” safety razors include a disposable razor cartridge adapted to be selectively connected to a reusable handle by connecting structure therebetween. When the cartridge is perceived by a user to have reached the end of its useful life it can be ejected from the handle by operation of an actuator or release button connected to a suitable cartridge connection and release mechanism. A reusable handle including such a mechanism requires multiple component parts, generally of different materials. For environmental benefits including subsequent recyclability it would be beneficial to use a single material for the entire handle assembly. For manufacturing advantages it would be beneficial for any multi-part assembly to be replaced by a single component part. A further advantage is for the handle to pivotally support the connected razor cartridge, i.e. the cartridge is pivotal about at least one axis relative to the handle.

### SUMMARY

The present disclosure has for its objective to substantially alleviate the limitations of the prior art safety razor handles by providing a razor handle comprising a single (monolithic) component part, preferably of a single (mono-) material and pivotally supporting a cartridge connected thereto. The handle has a first arm and a second arm both joined at a connection end. Each arm has pivotal support structure at terminal ends of the arms opposite the connection end, that can be outwardly facing, to pivotally support the razor cartridge. A top cover extends inwardly of a head end region of one of the arms, and a bottom cover extends inwardly of a head end region of the other of the arms. The top and the bottom cover, in combination with the head end regions of the two arms at least partially enclose structures that both interconnect the head end regions to define a primed-condition predetermined dimension (W) across the pivotal support structures, and permit the head end regions to be guidedly flexed together upon application of a user's finger pressure to the head end regions. The handle also has a biasing member integrally formed with one of the arms. The biasing member has a distal end adapted to contact the razor cartridge to impart a force on the cartridge to create a restoring torque to return the cartridge to a neutral position relative to the handle.

In some aspects of the present disclosure the interconnecting structures of the head end regions include a beam that extends inwardly from one of the arms into a region at least partially bounded by the top and bottom covers and the head end regions. The beam terminates in a snap fit protrusion to snap-fittingly engage an offset rib that extends inwardly into the bounded region from the other of the arms.

In some aspects of the present disclosure a gap (D) is provided between a tip of the beam of one arm to a stop rib of the other arm to permit the head end regions to be flexed together until the tip abuts stop rib. In further aspects the guiding structure of the head end regions includes structure attached to one of the arms having inwardly directed surfaces that define a slot elongated in a direction of the gap to slidingly receive a protrusion defined by outwardly facing surfaces of structure of the other arm.

In some aspects of the present disclosure the user's finger pressure can be applied to finger pads of the head end regions.

In some aspects of the present disclosure the biasing member comprises a cantilever beam having a distal end adapted to contact the razor cartridge, and a root end integrally formed with torsion arms on each opposed longitudinal side of the cantilever beam. An outer end of a first of the torsion arms has the integral joint with the arm at a torsion arm root, and an outer end of the second of the torsion arms terminates in a lead-in structure having an adjacent stop surface, the lead-in structure being received in an aperture of the other arm, and the stop surface engaging an inner surface of the apertured arm.

In some aspects of the present disclosure each arm includes an inward facing fulcrum positioned to contact a fulcrum of the other respective arm. In further aspects one or more local joints are provided that interconnect a connection end region of each arm extending between the respective fulcrum and the connection end. In some aspects each local joint comprises a snap fit between an inwardly extending hook of one arm and an inwardly extending mating hook of the other arm.

Some further aspects of the present disclosure lie in a compound biasing member portion of a monolithic razor handle. The biasing member includes a cantilever beam having a distal end adapted to contact a razor cartridge connected to the handle, and a root end integrally formed with a first and a second torsion arm on each opposed longitudinal side of the cantilever beam. An outer end of the first torsion arm is integrally formed with a first arm of the handle at a torsion arm root, and an outer end of the second torsion arm terminates in a lead-in structure having an adjacent stop surface. The lead-in structure is received in an aperture of a second arm of the handle, and the stop surface engages an inner surface of the second arm adjacent the aperture. The imparted force of the biasing member upon the razor cartridge is provided by both of flexure of the cantilever of the biasing member and torsion of the torsion arms of the biasing member.

In some aspects of the present disclosure the torsion arms are positioned in a general V arrangement relative to each other with the V extending transversely of a length of the cantilever beam, and with the root end of the biasing member at the intersection of the V.

The handle therefore comprises a monolithic (single and integrally formed) component part). The handle can pivotally support a razor cartridge and a biasing member biases the cartridge to a neutral position. Pivotal support structures of the handle are capable of being guidedly deflected by a defined dimension to permit a razor cartridge to be connected to, or disconnected from, the handle. The handle emulates a multi-part assembly.

The above features and advantages will be more fully understood with reference to the following detailed description when taken in conjunction with the accompanying drawings.

### BRIEF DESCRIPTION OF THE DRAWINGS

FIG. 1 is a perspective view of a safety razor handle of the present disclosure in an as-molded condition;

FIG. 2 is a perspective view of a handle in a primed condition;

FIG. 3 is a plan view of the handle of FIG. 1;

FIG. 4 is a plan view of the handle of FIG. 2;

FIG. 5 is a detailed portion “5” of FIG. 3;

FIG. 6 is a sectional view of FIG. 4, taken at 6-6;

FIG. 7 is a sectional view of FIG. 4, taken at 7-7;

FIG. 8 is a sectional view of FIG. 4, taken at 8-8;

FIG. 9 is a sectional view of FIG. 3 taken at 9-9;

FIG. 10 is a sectional view of FIG. 3 taken at 10-10; and

FIG. 11 is a sectional view of FIG. 4 taken at 11-11.

### DETAILED DESCRIPTION

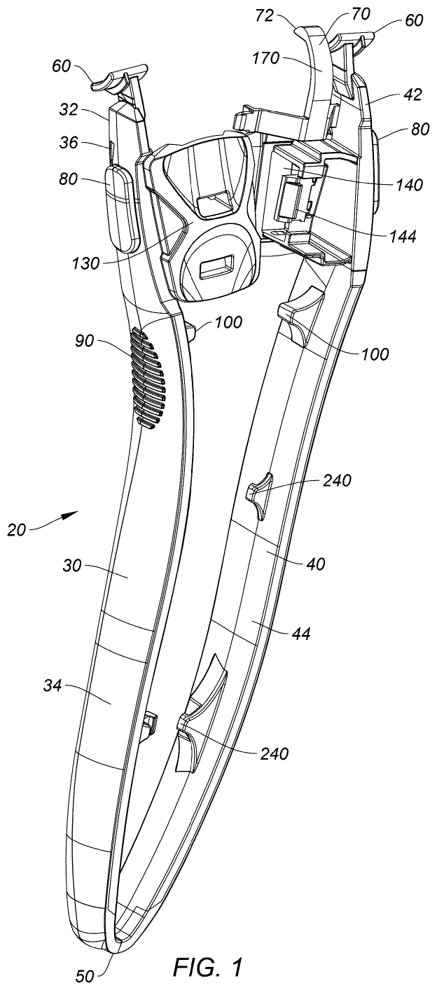

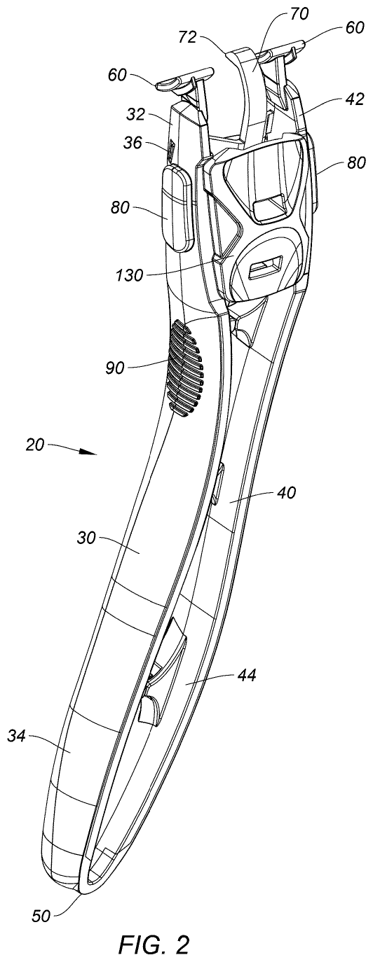

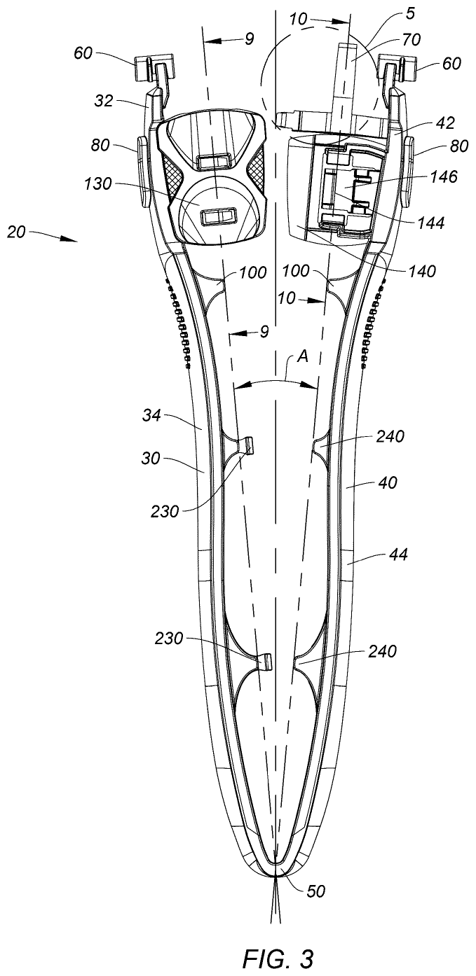

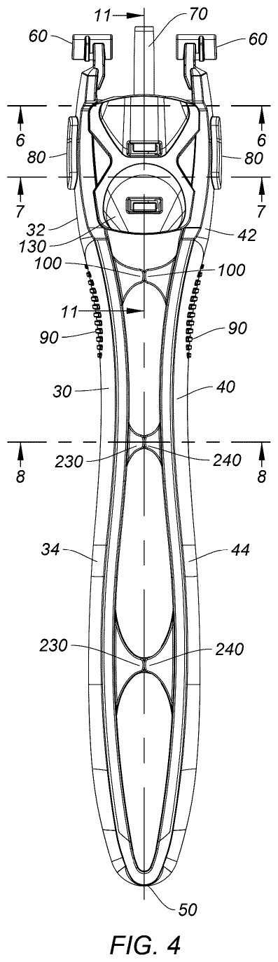

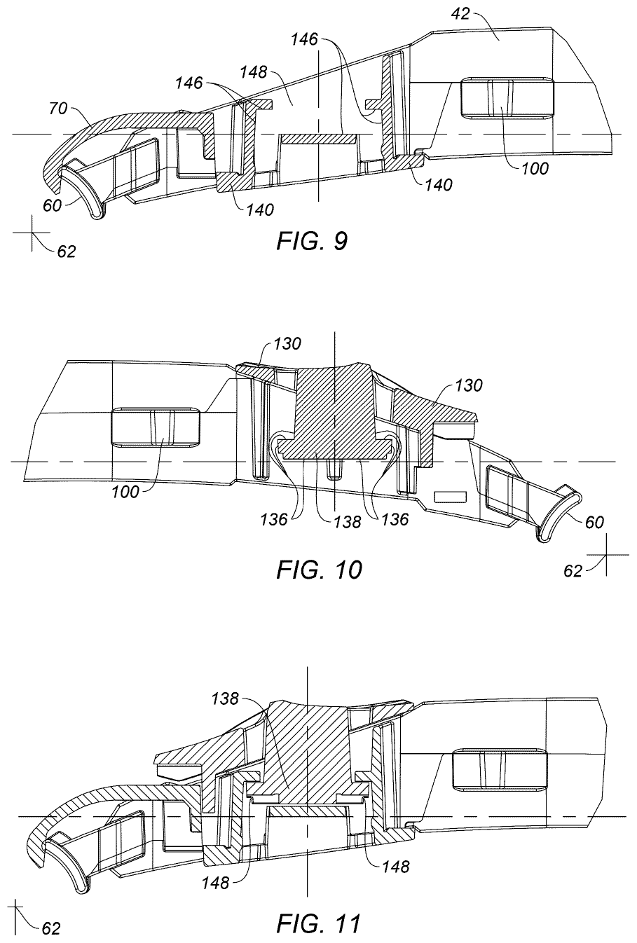

Referring to the drawings, and in particular FIGS. 1 to 4, perspective and plan views of a monolithic (single and integrally formed component part) razor handle 20 are depicted. In FIGS. 1 and 3, the handle 20 is in the as-molded condition. In FIGS. 2 and 4 the handle 20 is primed or ready-for-use, as described later in the present disclosure. The handle 20 has a first arm 30 and a second arm 40. The arms 30, 40 are joined at a connection end 50, to provide a general U or V shape for the handle 20. In FIGS. 1 and 3, the arms 30, 40 as-molded are at an angle A to each other (see FIG. 3) that can be about 10 degrees. At terminal ends opposite the connection end 50, each arm 30, 40 has an outwardly facing (see FIG. 4) pivotal support structure 60, to engage mating structure of a razor cartridge (not shown) to permit the cartridge to pivot relative to the handle 20 about axis 62 (see FIGS. 9-10) in response to externally applied forces encountered during use. In the primed condition a predetermined dimension W (see FIG. 8) is defined across the pivotal support structures 60 of the arms 30, 40. Dimension W is sized to engage the mating structure of the razor cartridge without imparting frictional effects at the extreme outer end surfaces of the pivotal support structures 60 (i.e. if dimension W were to be greater than a corresponding mating dimension of the cartridge). As depicted, the pivotal support structures 60 comprises arcuate rails that are coaxially arranged when the handle 20 is in the primed condition, and that engage arcuate grooves of the cartridge. However, other types of support structure 60 can be employed, e.g. pin-in-hole arrangements, or living hinges, e.g. that can provide a 4-bar link arrangement. Each arm 30, 40 can include an inward facing fulcrum 100 positioned to contact a fulcrum 100 of the other respective arm 40, 30, e.g. in the primed condition, and provided such that a head end region 32, 42 of each respective arm 30, 40 (i.e. each region adjacent the pivotal support structures 60, and/or each region between the fulcrum 100 and pivotal support structure 60) can flex about its fulcrum 100 when a user operates the handle 20 to connect or disconnect a razor cartridge. A connection end region 34, 44 of each respective arm 30, 40 extends from a respective fulcrum 100 to the connection end 50. Each head end region 32, 42 can be provided with an outwardly facing finger pad 80 to indicate where a user may apply finger pressure to flex the arm head end regions 32, 42 together to reduce dimension W across the pivotal support structures 60 in order to connect or disconnect the cartridge. Each arm 30, 40 can also be provided with textured regions 90 to aid gripping the handle 20 during use.

The skilled worker will be aware that the flexibility of the arm head end regions 32, 42 to provide a secure connection of the razor cartridge to the handle 20 (e.g. the ability to withstand external disconnection forces), and disconnection, both under desired finger pressure, is a function of many variables of the handle design (and finger strength of the user). Major amongst these variables are an elastic modulus of the handle material (described later in the present disclosure); a length dimension between the fulcrum 100 and the pivotal support structures 60; a second moment of area of the head end regions 32, 42. The use of a fulcrum 100 functionally ‘shortens’ the handle 20, since without the fulcrums 100, each arm 30, 40 would flex over its entire length from the connection end 50 to its respective pivotal support structure 60. In some circumstances a designer may choose to omit fulcrums 100 and compensate ‘flexibility-wise’ by adjusting any of the handle's material (thus elastic modulus), second moment of area, and handle length.

In instances where a fulcrum 100 is provided, when a user applies finger pressure at the finger pads 80 to flex the arm head end regions 32, 42 together (to reduce dimension W), a reaction of this force tends to flex the connection end regions 34, 44 of the arms 30, 40 (the arm regions between the fulcrum 100 and the connection end 50) apart, undesirably causing the handle 20 to bulge in the connection end regions 34, 44. To mitigate this, one or more local joints (e.g. two, as depicted) can be provided interconnecting the connection end regions 34, 44 of the arms 30, 40. For example, referring to FIG. 8, a suitable joint can be a local snap fit created between a hook 240 of arm 40 and a mating hook 230 of arm 30.

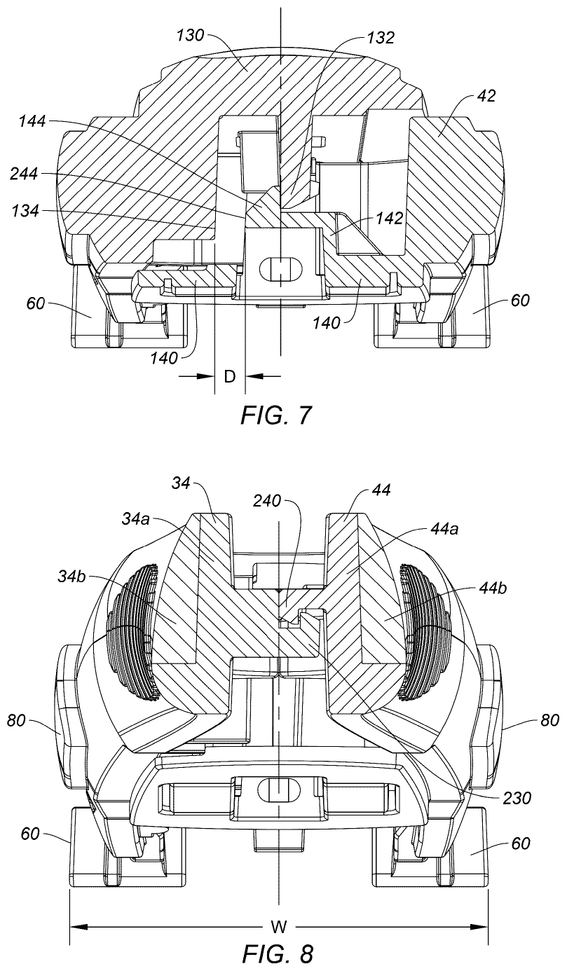

The handle 20 includes a top cover 130 integrally formed with a first head end region 32, 42 (e.g. head end region 32) and a bottom cover 140 integrally formed with the other head end region 42, 32 (e.g. head end region 42). The covers 130, 140 both extend inwardly of the head end regions 32, 42. The covers 130, 140 both at least partially enclose internal structures that interconnect the head end regions 32, 42 to define the primed condition, and permit the head end regions 32, 42, to be flexed together by a predetermined distance. The covers 130, 140 further at least partially cover a biasing member 70, as described later. Covering these features prevents a user accidentally touching these features during use, potentially disconnecting a snap fit (described below), potentially affecting cartridge biasing, and provides aesthetic benefits. Referring now to FIG. 7, one arm 30, 40 of the handle 20 (e.g. arm head end region 42) includes a beam 142 that extends into a region at least partially bounded by the top and bottom covers 130, 140, and the head end regions 32, 42. The beam 142 terminates in a snap fit protrusion 144. The snap fit protrusion 144 snap-fittingly engages offset rib 132 that extends into the bounded region from the other of the arms 40, 30 (e.g. arm head end region 32). A gap D is provided between a tip 244 of beam 142 to a stop rib 134 of head end region 32 to permit the head end regions 32, 34 (and therefore pivotal support structures 60) to be flexed together until tip 244 abuts stop rib 134. Referring now to FIGS. 9 and 10, one arm 30, 40 of the handle 20 (e.g. arm head end region 32) includes structure having inwardly directed surfaces 146 that define an elongated slot 148 elongated in the direction of gap D. Elongated slot 148 slidingly receives a protrusion 138 defined by outwardly facing surfaces 136 of structure of the other arm 40, 30 of the handle 20 (e.g. arm head end region 32). As mentioned above, elongated slot 148 and protrusion 138 are also at least partially enclosed by the top and bottom covers 130, 140. The sliding fit between the protrusion 138 in the slot 148 provides guidance to control the direction in which the head end regions 32, 42 flex together, and return to their primed condition to ensure correct connection of the razor cartridge to the handle, and that the pivotal support structures 60 of the arms 30, 40 are coaxial in the primed condition. FIG. 11 is a center-line sectional view of FIG. 4, i.e. of the handle 20 in the primed condition, and shows protrusion 138 received in elongated slot 148. Since in the as-molded condition (of FIGS. 1 and 3) the arms are at an angle A to each other, when the handle 20 is primed (snap fit protrusion 144 snap-fittingly has engaged offset rib 132), the arms 30, 40 are necessarily flexed towards each other. This provides a biasing force to bias the arms to the primed condition after the head end regions 32, 42 have been flexed together and released.

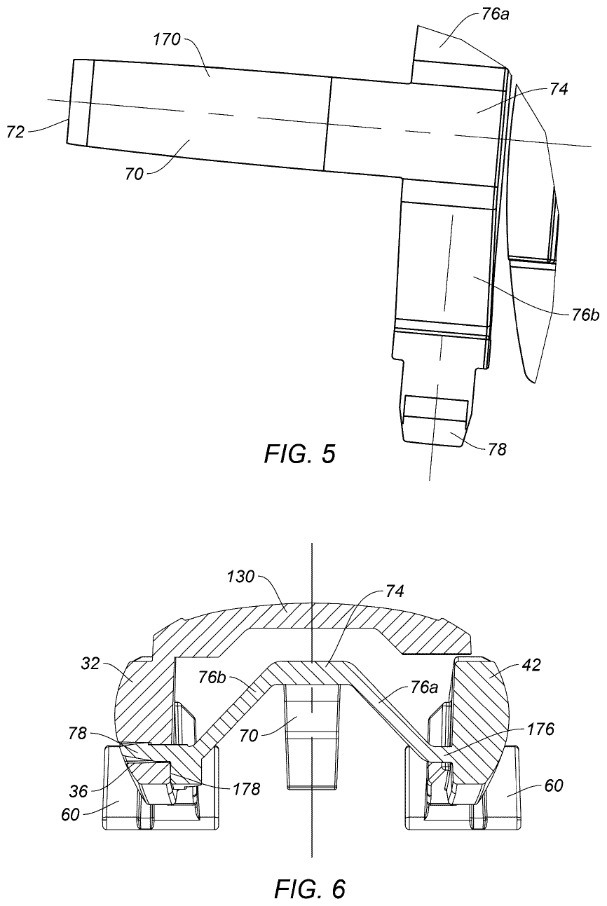

The handle 20 includes a biasing member 70. The biasing member 70 has a distal end 72 adapted to contact a razor cartridge when connected to the handle 20. The biasing member 70 imparts a force on the cartridge that creates a restoring torque to return the cartridge to a neutral angular (pivotal) position relative to the handle 20 after externally applied in-use forces are removed. As depicted, the biasing member 70 includes a cantilever beam 170 having the distal end 72 and a root end 74. The root end 74 is connected to torsion arms 76a, 76b on each opposed longitudinal side of the cantilever beam 170 (see also FIG. 6). As seen in FIGS. 1 and 3 the biasing member 70 is integrally formed with one of the arms 30, 40 (as depicted, arm 40) via one of the torsion arms 76a (see FIG. 6) at a torsion arm root 176. The other of the torsion arms 76b terminates at its outer end in guidance or lead-in structure 78 and having an adjacent stop surface 178. In FIG. 5 an enlarged portion of FIG. 3 is shown. In the primed condition of FIGS. 2, 4 and 6, the lead-in structure 78 is received in an aperture 36 of the other of the arms 40, 30. Stop surface 178 engages an inner surface of the arm 30 adjacent the aperture 36 to prevent further penetration of the lead-in structure 78 into aperture 36. As seen in FIG. 6, the torsion arms 76a, 76b are positioned in a general V arrangement relative to each other at an included angle of the V about 90 degrees, and with the torsion arms 76a, 76b extending transversely of a length of the cantilever beam 170, and with the root end 74 of the biasing member 70 at the intersection of the V. The torsion arms 76a, 76b can include straight or curved portions providing the torsion arms 76a, 76b do not block operation of the handle 20 when a user applies finger pressure to flex the head end regions 32, 42 together since they have a capability of flexing. As a skilled worker can deduce, the arrangement of the torsion arms 76a, 76b will permit a general included angle of the V to reduce as the torsion arms 76a, 76b deflect under finger pressure. As a secondary effect, this deflection of the torsion arms 76a, 76b provides an additional biasing force to bias the end regions 32, 42 of the arms 30, 40 apart to the primed condition after finger pressure is removed. As a tertiary effect, engagement of the lead-in structure 78 (that is indirectly integrally formed with a one of the arms 30, 40), in aperture 36 of the other of the arms 40, 30 assists coaxial alignment of the pivotal support structures 60 of the arms 30, 40 to enable correct connection and pivotal support of the razor cartridge on the handle 20. As a quaternary effect, the imparted force upon the razor cartridge is provided by both of flexure of the cantilever 170 of the biasing member 70, and torsion of the torsion arms 76a, 76b, since each respective outer end 78, 176 of the torsion arms 76a, 76b is torsionally constrained. The biasing member 70 is a compound biasing member having both a flexural portion and a torsional portion.

The handle 20 is preferably manufactured by injection molding, e.g. single-, two- or multi-shot injection molding. An advantage of using two- or multi-shot methods to mold a single material component part lies in potential reduction of molding cycle time compared to single-shot molding by reducing the cooling time portion of the molding cycle. Also, the two- or multi-shots can have e.g. different colors for aesthetic benefits. FIG. 8 shows an exemplary partition between a first-shot 34a, 44a and second-shot 34b, 44b respectively of arms 30, 40. The handle 20 can be molded from polypropylene (PP) for benefits including recyclability and chemical resistance to substances typically found in use. A suitable polypropylene is MOPLEN RP344RK provided by LYONDELLBASELL NV. Other materials such as ABS (acrylonitrile butadiene styrene) also have utility. Recycled materials, e.g. recycled polypropylene (rPP) can also be used. Alternatively, a first shot can be PP (rPP) and a second shot can be a thermoplastic elastomer (TPE or rTPE) where the TPE is based on modified PP (e.g. a propylene monomer) such that the handle 20 still comprises effectively a single material for the purposes of further recyclability. The first shot can also be ABS (rABS) with a second TPE (rTPE) shot based on a styrene monomer. The TPE portion can provide haptic benefits to a user.

The handle 20 comprises of a monolithic (single and integrally formed) component part). The handle 20 can pivotally support a razor cartridge and a biasing member 70 biases the cartridge to a neutral position. Pivotal support structures 60 of the handle 20 are capable of being guidedly deflected by a defined dimension (gap D) to permit a razor cartridge to be connected to, or disconnected from, the handle 20. The handle 20 emulates a multi-part assembly.

While various embodiments have been described above it should be understood that they have been presented by way of example only, and not limitation. For instance, modifications or changes as can be made within the scope of the connected claims and features disclosed in connection with any one embodiment can be used alone or in combination with each feature of the respective other embodiments. Thus, the breadth and scope of any embodiment should not be limited by any of the above-described exemplary embodiments but should be defined only in accordance with the following claims and their equivalents.

1. A monolithic handle for a safety razor having a razor cartridge connected to the handle, comprising:
a first arm and a second arm both joined at a connection end, each arm having structure to pivotally support the razor cartridge at terminal ends of the arms opposite the connection end; a top cover extending inwardly of a head end region of one of the arms, and a bottom cover extending inwardly of a head end region of the other of the arms; the top and the bottom cover in combination with the head end regions at least partially enclosing structures that both interconnect the head end regions to define a primed-condition predetermined dimension across the pivotal support structures, and permit the head end regions to be guidedly flexed together upon application of a user's finger pressure to the head end regions; and
a biasing member integrally formed with one of the arms having a distal end adapted to contact the razor cartridge to impart a force on the cartridge to create a restoring torque to return the cartridge to a neutral position relative to the handle.

2. The handle of claim 1, wherein the interconnecting structures of the head end regions include a beam that inwardly extends from one of the arms into a region at least partially bounded by the top and bottom covers and the head end regions, the beam terminating in a snap fit protrusion to snap-fittingly engage an offset rib that inwardly extends into the bounded region from the other of the arms.

3. The handle of claim 2, wherein a gap is provided between a tip of the beam of one arm to a stop rib of the other arm to permit the head end regions to be flexed together until the tip abuts stop rib.

4. The handle of claim 3, wherein the guiding structure of the head end regions includes structure attached to one of the arms having inwardly directed surfaces that define a slot elongated in a direction of the gap to slidingly receive a protrusion defined by outwardly facing surfaces of structure of the other arm.

5. The handle of claim 3, wherein the user's finger pressure is applied to finger pads of the head end regions.

6. The handle of claim 3, wherein the biasing member comprises a cantilever beam having a distal end adapted to contact the razor cartridge, and a root end integrally formed with a first torsion arm and a second torsion arm on each opposed longitudinal side of the cantilever beam; wherein an outer end of the first torsion arm has the integral joint with the arm at a torsion arm root; and an outer end of the second torsion arm terminates in a lead-in structure having an adjacent stop surface, the lead-in structure being received in an aperture of the other arm, and the stop surface engages an inner surface of the arm adjacent the aperture.

7. The handle of claim 6, wherein each arm includes an inward facing fulcrum positioned to contact a fulcrum of the other respective arm.

8. The handle of claim 7, wherein one or more local joints are provided that interconnect a connection end region of each arm extending between the respective fulcrum and the connection end.

9. The handle of claim 8, wherein each local joint comprises a snap fit between an inwardly extending hook of one arm and an inwardly extending mating hook of the other arm.

10. The handle of claim 8, wherein the pivotal support structures of each arm are outwardly facing.

11. A compound biasing member portion of a monolithic razor handle, comprising:
a cantilever beam having a distal end adapted to contact a razor cartridge connected to the handle, and a root end integrally formed with a first torsion arm and a second torsion arm, each on opposed longitudinal side of the cantilever beam;
wherein an outer end of the first torsion arm is integrally formed with a first arm of the handle at a torsion arm root; and
an outer end of the second of the torsion arms terminates in a lead-in structure having an adjacent stop surface, the lead-in structure being received in an aperture of a second arm of the handle, and the stop surface engaging an inner surface of the second arm adjacent the aperture; and
wherein the imparted force of the biasing member upon the razor cartridge is provided by both of flexure of the cantilever of the biasing member and torsion of the torsion arms of the biasing member.

12. The compound biasing member of claim 10, wherein the torsion arms are positioned in a general V arrangement relative to each other with the V extending transversely of a length of the cantilever beam, and with the root end of the biasing member at the intersection of the V.
